(19) United States
(12) Patent Application Publication
(10) Pub. No.: US 2026/0292293 A1
(43) Pub. Date: Sep. 24, 2026

(54) METHOD AND SYSTEM FOR PREVENTION OF HDMI CEC LINE DATA DROP BY DYNAMIC LOAD SHARING

(71) Applicant: SAMSUNG ELECTRONICS CO., LTD., Suwon-si (KR)

(72) Inventor: Umesh TANWAR, Noida (IN)

(73) Assignee: SAMSUNG ELECTRONICS CO., LTD., Suwon-si (KR)

(21) Appl. No.: 19/684,393

(22) Filed: May 21, 2026

Related U.S. Application Data
(63) Continuation of application No. PCT/KR2024/019385, filed on Nov. 29, 2024.

(30) Foreign Application Priority Data
Dec. 19, 2023 (IN) 202311086826

(51) Int. Cl. H04N 21/436; G09G 5/00; H04N 21/258

(52) U.S. Cl. CPC H04N 21/43615; G09G 5/006; H04N 21/25816; G09G 2370/06; G09G 2370/12

(57) ABSTRACT

A method performed by a first device for creating a dynamic link to prevent HDMI CEC line data drop, includes: transmitting, to a second device via an HDMI CEC line, a request message to create the dynamic link between the first device and the second device; receiving, from the second device via the HDMI CEC line, a response message including information associated with one or more connections available for creating the dynamic link; transmitting, to the second device via the HDMI CEC line, based on the information associated with the one or more connections available for creating the dynamic link, an authentication message including authentication data for creating the dynamic link; creating the dynamic link between the first device and the second device based on the authentication data; and controlling at least one of transmission or reception of one or more data items via the dynamic link.

### CROSS-REFERENCE TO RELATED APPLICATIONS

This application is a continuation of International Application No. PCT/KR2024/019385, filed on Nov. 29, 2024, which is based on and claims priority to Indian Patent Application number 202311086826, filed on Dec. 19, 2023, in the Indian Patent Office, the disclosures of which are incorporated by reference herein in their entireties.

### BACKGROUND

### 1. Field

The present disclosure relates to data transmission and reception, and more particularly, to method and system for prevention of data drop in High-Definition Multimedia Interface (HDMI) Consumer Electronics Control (CEC) lines.

### 2. Description of Related Art

Currently, a majority of digital devices use High-Definition Multimedia Interface (HDMI) as digital audio/video content transfer interface. HDMI came into existence as an advanced Audio Visual (AV) connector with version 1.0. Subsequently, Consumer Electronics Control (CEC) feature was introduced with HDMI version 1.2a. The CEC features enables devices to discover, command, and control other connected devices using one remote controller.

FIG. 1 illustrates a home theater system 100 including multiple HDMI CEC devices, according to a related art technique. As depicted, the home theater system 100 may include a television 102 coupled to a soundbar 104. In turn, the soundbar 104 may be coupled with a plurality of other HDMI CEC devices 106a-106c. Examples of HDMI CEC devices 106a-106c may include a set top box, a gaming console system, an entertainment system, and a digital media presentation system. The devices 106a-106c may be coupled via HDMI CEC and controlled via a single remote controller.

The HDMI CEC can support up to 15 devices at once to control the connected devices. The HDMI interface provided in the home theater system 100 has a dedicated line for CEC (e.g., pin 13), which works with a data rate of 417 bits per second, which is slow with the growing number of devices in modern era. At times, the input data rate on the CEC line becomes more than supported bit rate leading to data loss.

Apart from legacy CEC features, vendors define new vendor commands to implement vendor specific features. Thus, the load on CEC line is increasing day by day demanding higher speed of data transmission than supported by the CEC line, resulting in data drop. Currently, the CEC specification provides reliable communication by resending lost messages, which are re-sent within the limited bit rate supported therein. However, the higher speed data is lost forever. Currently, there is no method to prevent the data loss caused by high input data rate. Moreover, there is no method which allows non-HDMI devices to become a part of the HDMI network.

Accordingly, there is a need for systems and methods that overcome at least some of the above-mentioned limitations associated with HDMI CEC technology.

### SUMMARY

According to an aspect of the disclosure, there is provided an electronic device including: a communication interface configured to communicate with another device; memory storing instructions; and at least one processor, wherein the instructions, when executed by the at least one processor individually or collectively, cause the electronic device to: transmit, to the other device via a High-Definition Multimedia Interface (HDMI) Consumer Electronics Control (CEC) line, a request message to create a dynamic link between the electronic device and the other device); receive, from the other device via the HDMI CEC line, a response message in response to the transmitted request message, the response message including information associated with one or more connections available for creating the dynamic link; transmit, to the other device via the HDMI CEC line, based on the information associated with the one or more connections available for creating the dynamic link, an authentication message including authentication data for establishing the dynamic link; create the dynamic link between the electronic device and the other device based on the authentication data; and control at least one transmission or reception of one or more data items via the dynamic link.

According to an aspect of the disclosure, there is provided a method performed by a first device for creating a dynamic link to prevent High-Definition Multimedia Interface (HDMI) Consumer Electronics Control (CEC) line data drop, the method including: transmitting, to a second device via an HDMI CEC line, a request message to create the dynamic link between the first device and the second device; receiving, from the second device via the HDMI CEC line, a response message in response to the transmitted request message, the response message including information associated with one or more connections available for creating the dynamic link; transmitting, to the second device via the HDMI CEC line, based on the information associated with the one or more connections available for creating the dynamic link, an authentication message including authentication data for creating the dynamic link; creating the dynamic link between the first device and the second device based on the authentication data; and controlling at least one of transmission or reception of one or more data items via the dynamic link.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a home theater system including multiple HDMI CEC devices, according to related art techniques;

FIG. 2 illustrates an exemplary overview of an environment including a first device, a second device, and a system to create a dynamic link, according to an embodiment of the present disclosure;

FIG. 3 illustrates a detailed block diagram of the system, according to an embodiment of the present disclosure;

FIG. 4 illustrates a schematic diagram illustrating the operation flow among the first device and the second device, according to an embodiment of the present disclosure;

FIG. 5 illustrates a line diagram showing exchange of CEC messages between the first device and the second device, according to an embodiment of the present disclosure;

FIG. 6 illustrates an operational flow associated with the data loss predictor module, according to an embodiment of the present disclosure;

FIG. 7 illustrates an exemplary process flow of a method for creating a dynamic link, according to an embodiment of the present disclosure;

FIG. 8 illustrates a graphical representation showing a comparison of data drop as per the method disclosed herein and data drop as per related art techniques, according to an embodiment of the present disclosure; and

FIGS. 9A and 9B illustrate various exemplary usage scenarios of the system for creating a dynamic link, according to an embodiment of the present disclosure.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

Reference throughout this specification to “an aspect”, “another aspect” or similar language means that a particular feature, structure, or characteristic described in connection with the embodiment is included in at least one or more embodiments of the present disclosure. Thus, appearances of the phrase “in an embodiment”, “in another embodiment” and similar language throughout this specification may, but do not necessarily, all refer to the same embodiment.

The terms “comprise”, “comprising”, “include”, “including”, or any other variations thereof, are intended to cover a non-exclusive inclusion, such that a process or method that comprises or includes a plurality of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

As used herein, the expression, “at least one of A, B, and C,” should be understood as including only A, only B, only C, both A and B, both A and C, both B and C, or all of A, B, and C.

The terms “multi-party conversation”, “human-to-human conversation”, and “conversation”, may be used interchangeably throughout the description. The terms “user device”, “device”, and “electronic device” along with their inherent variations may be used interchangeably throughout the description.

According to one or more embodiments of the present disclosure, a method implemented in a first device for creating a dynamic link to prevent High-Definition Multimedia Interface (HDMI) Consumer Electronics Control (CEC) line data drop is disclosed. According to another embodiment, a system implemented in a first device for creating a dynamic link to prevent HDMI CEC line data drop is disclosed. According to another embodiment, a sender device for creating a dynamic link to prevent HDMI CEC line data drop is disclosed.

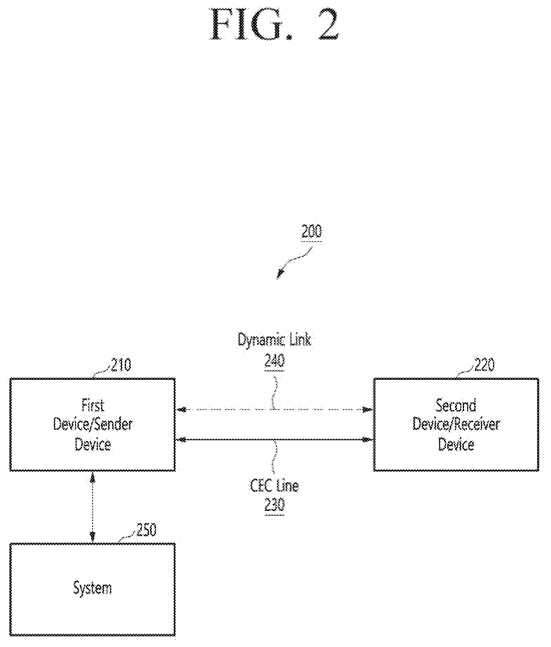

FIG. 2 illustrates an exemplary overview of an environment 200 including a first device 210 and a second device 220 communicably coupled with each other. In one or more embodiments, the first device 210 may be referred to as a sender device and the second device 220 may be referred to as a receiver device. The first device 210 may communicate and exchange data with the second device 220 via an HDMI CEC line 230. The first device 210 may additionally communicate and exchange data with the second device 220 via a dynamic link 240, as will be described further below.

In an embodiment, the first device 210 and the second device 220 may include, but is not limited to, televisions, smart speakers, soundbars, music plyer, mobiles, smart watches, laptops, and other smart devices which may or may not support HDMI connectivity. The first device 210 and the second device 220 may include the necessary components for exchange of data via the HDMI CEC line 230, as would be apparent to a skilled person in the art and the same have not be described herein for sake of brevity.

The environment 200 may further include a system 250 configured to create or establish the dynamic link 240 and prevent HDMI CEC line data drop. In an embodiment, the system 250 may be implemented at the first device 210. The details explained with reference to the system 250 may be understood as being performed by the first device 210 when the system 250 is integrated within the first device 210.

In other embodiments, the system 250 may be a standalone entity located at a remote location and connected to the first device 210 via any suitable network. In one or more embodiments, the system 250 may be implemented in a distributed manner, in that, one or more components of the system 250 may be implemented within the first device 210, while one or more components of the system 250 may be implemented within a cloud-based server or a physical server.

The system 250 may be configured to creating the dynamic link 240 to prevent HDMI CEC line data drop. The system 250 may be configured to perform operations and achieve the technical advantages by performing one or more operations as explained in detail at least with reference to FIGS. 2 to 7.

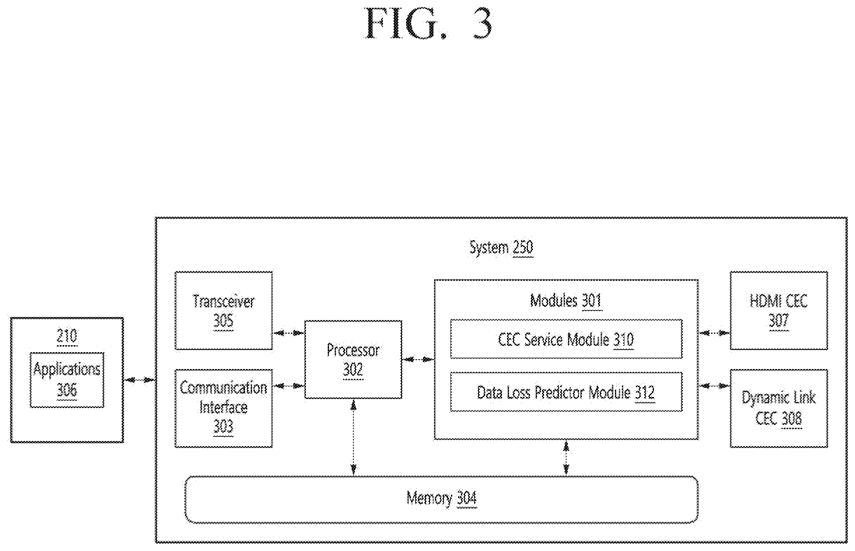

Reference is made to FIG. 3 which illustrates a detailed block diagram of the system 250, according to an embodiment of the present disclosure. The system 250 may include a plurality of modules 301, at least one processor 302, an communication interface 303, memory 304, and a transceiver 305. The system 250 may be in communication with one or more applications 306 of the first device 210 that require CEC operations. The system 250 may implement various connectivity capabilities, such as, but not limited to Wi-Fi, Bluetooth, optical connection, HDMI, and other interfaces, through the communication interface 303. The system 250 may further include various platforms such as HDMI CEC block 307 for implementing CEC standards through HDMI interface and dynamic link CEC block 308 for implementing CEC standard in different connectivity interfaces.

In an exemplary embodiment, the processor 302 may be operatively coupled to each of the communication interface 303, the plurality of modules 301, the transceiver 305, and the memory 304. In one or more embodiments, the processor 302 may include a graphical processing unit (GPU) and/or an AI Engine (AIE). In one or more embodiments, the processor 302 may include at least one data processor for executing processes in virtual storage area network. The processor 302 may include specialized processing units such as integrated system (bus) controllers, memory management control units, floating point units, graphics processing units, digital signal processing units, etc. In one or more embodiments, the processor 302 may include a central processing unit (CPU), a graphics processing unit (GPU), or both. The processor 302 may be one or more general processors, digital signal processors, application-specific integrated circuits, field-programmable gate arrays, servers, networks, digital circuits, analog circuits, combinations thereof, or other now known or later developed devices for analyzing and processing data. The processor 302 may execute a software program, such as code generated manually (i.e., programmed) to perform the desired operation.

The processor 302 may be disposed in communication with one or more input/output (I/O) devices via the communication interface 303. In one or more embodiments, the processor 302 may communicate with the first device 210 using the communication interface 303. In one or more embodiments, the communication interface may be implemented within the first device 210. Using the communication interface 303, the system 250 may communicate with external devices, such as the second device 220. In an embodiment, the communication interface 303 may include the connectivity capabilities as mentioned above.

The processor 302 may be in communication with a communication network via a network interface. In an embodiment, the network interface may be the communication interface 303. The network interface may connect to the communication network to enable connection of the system 250 with the first device 210 and/or the second device 220. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 250 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In one or more embodiments, the memory 304 may be communicatively coupled to the processor 302. The memory 304 may be configured to store data, instructions executable by the processor 302. In one or more embodiments, the memory 304 may be provided within the first device 210. In another embodiment, the memory 304 may be provided within the system 250 being remote from the first device 210. In yet another embodiment, the memory 304 may communicate with the processor 302 via a bus within the system 250. In yet another embodiment, the memory 304 may be located remote from the processor 302, and may be in communication with the processor 302 via a network. The memory 304 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 304 may include a cache or random-access memory for the processor 302. In alternative examples, the memory 304 is separate from the processor 302, such as a cache memory of a processor, the system memory, or other memory. The memory 304 may be an external storage device or database for storing data. The memory 304 may be operable to store instructions executable by the processor 302. The functions, acts or tasks illustrated in the figures or described may be performed by the programmed processor 302 for executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In one or more embodiments, the plurality of modules 301 may be included within the memory 304. The memory 304 may further include a database to store data. The plurality of modules 301 may include a set of instructions that may be executed by the processor 302 to cause the system 250 to perform any one or more of the methods/processes disclosed herein. The plurality of modules 301 may be configured to perform the operations of the present disclosure using the data stored in the database. In an embodiment, each of the plurality of modules 301 may be a hardware unit which may be outside the memory 304. Further, the memory 304 may include an operating system for performing one or more tasks of the system 250, as performed by a generic operating system.

The transceiver 305 may be configured to receive and/or transmit signals to and from the first device 210. In one or more embodiments, the database may be configured to store the information as required by the plurality of modules 301 and the processor 302 to perform one or more functions for creating the dynamic link 240 between the first device 210 and the second device 220 and preventing HDMI CEC line data drop.

The plurality of modules 301 may include, but not limited to, a CEC service module 310 and a data loss predictor module 312. The plurality of modules 301 may be implemented by way of suitable hardware and/or software applications.

The at least one processor 302 may include one processor or a plurality of processors. The at least one processor 302 may be one or more of a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The at least one processor 302 controls the processing of the input data in accordance with a predefined operating rule stored in the non-volatile memory or may employ a suitable artificial intelligence (AI) model executed from a server or a local memory module.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, active learning and reinforcement learning. The processor 302 may perform pre-processing operations on the data to convert it into a form appropriate for use as an input for the artificial intelligence (AI) model.

Reasoning prediction is a technique of logically reasoning and predicting by determining information and includes, e.g., knowledge-based reasoning, optimization prediction, preference-based planning, or recommendation.

Further, the present disclosure contemplates a computer-readable medium that includes instructions or receives and executes instructions responsive to a propagated signal. Further, the instructions may be transmitted or received over the network via a communication port or interface or using a bus. The communication port or interface may be a part of the processor 302 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 250 may be physical or may be established wirelessly. The network may alternatively be directly connected to a bus. For the sake of brevity, the architecture and standard operations of the memory 304, the processor 302, the transceiver 305, and the communication interface 303 are not discussed in detail.

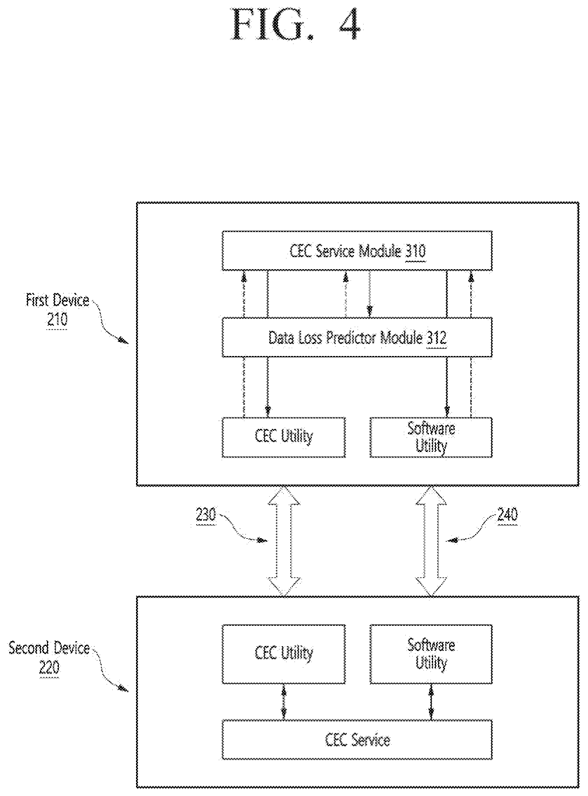

FIG. 4 illustrates a schematic diagram illustrating the operation flow among the first device 210 and the second device 220. The details of the present disclosure will now be described by collectively referring to FIGS. 2, 3, and 4.

In one or more embodiments, communication may be established between the first device 210 and the second device 220. The communication may be via the HDMI CEC line 230, as shown by the corresponding CEC utility blocks for the first device 210 and the second device 220. In one or more embodiments, the system 250, in particular the CEC service module 310, may transmit a request message from the first device 210 via the HDMI CEC line 230 to create the dynamic link 240 between the second device 220 (receiver device) and the first device 210 (sender device). The request message may be transmitted in accordance with CEC standards. In one or more embodiments, the request message may be transmitted upon a determination that there is data loss in the HDMI CEC line 230.

In one or more embodiments, the system 250 shares the connectivity capabilities of the first device 210 with the second device 220 through the request message. That is, the request message includes connectivity capabilities of the first device 210 to connect with the second device 220. As mentioned previously, the connectivity capabilities may include Bluetooth, Wi-Fi, Ethernet, Optical connection, and the like in accordance with non-limiting examples.

In one or more embodiments, the system 250 may be configured to create the dynamic link 240 between the first device 210 and the second device 220 using a selected capability of the multiple connectivity capabilities. In one or more embodiments, the selected capability may be an optimal connectivity based on availability of the connections through the selected capability as well as data transmission parameters associated with the selected capability.

In one or more embodiments, the system 250 may be configured to identify the optimal connectivity based on connectivity capabilities of the first device 210, the one or more connections that are available with the second device 220, and data transmission speed of the one or more connections available with the second device 220. The dynamic link 240 may thus be created using the optimal connectivity.

The system 250 may be configured to receive, from the second device 220, information related to the one or more connections available with the second device 220. The system 250, in particular the CEC service module 310, may receive a response message from the second device 220 via the HDMI CEC line 230. The response message may include information associated with one or more connections available at the second device 220 for creating the dynamic link 240. In one or more embodiments, the response message may be received from the second device 220 in response to the request message received at the second device 220. In non-limiting examples, the one or more connections available at the second device 220 may include a Wi-Fi connection, a Bluetooth connection, an optical connection, an Ethernet connection, and the like.

Further, the system 250, in particular the CEC service module 310, may be configured to transmit an authentication message to the second device 220 based on the information received in the response message from the second device 220. The authentication message may include authentication data for creating the dynamic link 240. The authentication data may be used while implementing the connection between the first device 210 and the second device 220. As an example, in case the dynamic link 240 is over a Bluetooth connection, the authentication data may include Bluetooth Media Access Control (BT MAC) address. As another example, in case the dynamic link 240 is over a Wi-Fi connection, the authentication data may include authentication information associated with the Wi-Fi connection.

Based on the authentication data, the system 250, in particular the CEC service module 310 may be configured to create the dynamic link 240 between the first device 210 and the second device 220 based on the authentication data transmitted to the second device 220. Using the dynamic link 240, data may be transmitted from the first device 210 to the second device 220.

In an embodiment, data may be transmitted independently over the dynamic link 240. In an embodiment, data may be transmitted from the first device 210 to the second device 220 over the dynamic link 240 in conjunction with the HDMI CEC line 230. The transmission of data from the first device 210 to the second device 220 may be via corresponding software utility blocks for the first device 210 and the second device 220, as shown in FIG. 4. The data transmission over the dynamic link 240 may be as per existing CEC standards, which is ensured by the dynamic link CEC block 308 (shown in FIG. 3). Accordingly, the load on the HDMI CEC line 230 may be shared due to the data transmission over the dynamic link 240, thereby reducing data drops on the HDMI CEC line 230.

In one or more embodiments, the system 250 may control transmission or reception of data, i.e., one or more data items over the dynamic link 240. In one or more embodiments, the system 250, in particular the CEC service module 310 may be configured to transmit a control message to the second device 220. The control message may enable controlling of the connection state of the dynamic link 240. For example, data transmission of the one or more data items may be paused and resumed over the dynamic link 240.

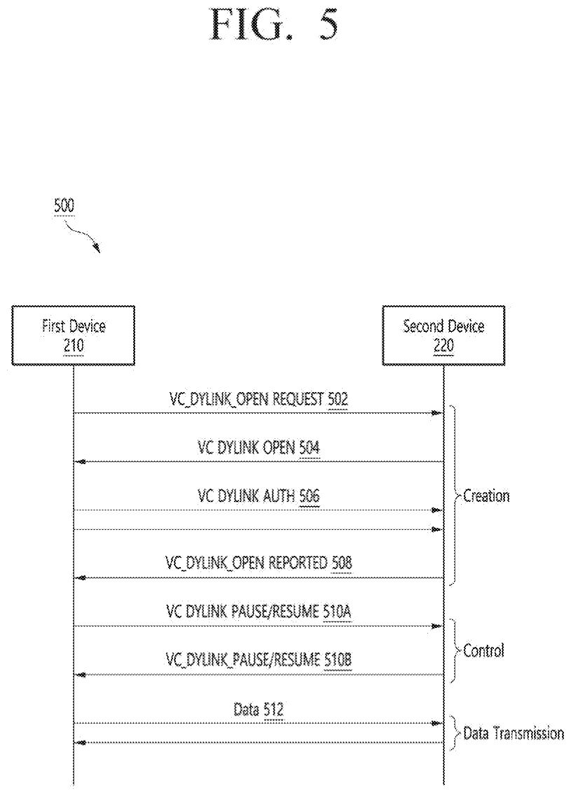

Referring to FIG. 5, a line diagram 500 showing exchange of CEC messages, i.e., request message, response message, authentication message, etc., between the first device 210 and the second device 220 is illustrated. At operation 502, a VC_DYLINK_OPEN_REQUEST may be sent by the first device 210 to the second device 220. The VC_DYLINK_OPEN_REQUEST may be associated with the connectivity capabilities of the first device 210 and requests to create the dynamic link 240 with the second device 220.

At operation 504, a VC_DYLINK_OPEN may be sent by the second device 220 to the first device 210. The VC_DYLINK_OPEN may be the response message of the VC_DYLINK_OPEN_REQUEST sent at operation 502. The VC_DYLINK_OPEN may indicate dynamic link creation between the first device 210 and the second device 220 with possible available connectivity options.

At operation 506, a VC_DYLINK_AUTH may be sent by the first device 210 to the second device 220. The VC_DYLINK_AUTH may be associated with authentication data required for successful connection over the dynamic link 240. As mentioned previously, the authentication data may include, for instance, Bluetooth MAC address for connection over Bluetooth serial port profile.

At operation 508, a VC_DYLINK_OPEN_REPORTED may be sent by the second device 220 to the first device 210. The VC_DYLINK_OPEN_REPORTED may be transmitted upon successful creation of the dynamic link 240 and successful transmission of test messages.

At operations 510A and 510B, VC_DYLINK_PAUSE/RESUME may be exchanged between the first device 210 and the second device 220. The VC_DYLINK_OPEN_REPORTED may be a control message to pause and/or resume the data transmission over the dynamic link 240.

At operation 512, data may be exchanged between the first device 210 and the second device 220 over the dynamic link 240 in conjunction with the HDMI CEC line 230. Thus, the load on the HDMI CEC line 230 is reduced and data drops on the HDMI CEC line 230 are prevented.

In one or more embodiments, the CEC messages, i.e., request message, response message, authentication message, etc., between the first device 210 and the second device 220 may be associated with a predefined structure or message format. The predefined structure may include a plurality of data blocks.

The plurality of data blocks may include, for a given message, one or more first data blocks to indicate a type of the message. That is, the uniqueness of the message may be identified. In one or more embodiments, Opcode and Code may be utilized as shown in Table 1 below:

TABLE 1

| CEC Message for Dynamic Link Creation | Opcode | Code |
|---|---|---|
| VC_DYLINK_OPEN_REQUEST | 0x89 | 0xD0 |
| VC_DYLINK_OPEN | 0x89 | 0xD1 |
| VC_DYLINK_AUTH | 0x89 | 0xD2 |
| VC_DYLINK_OPEN_REPORTED | 0x89 | 0xD3 |
| VC_DYLINK_PAUSE/RESUME | 0x89 | 0xD4 |

The plurality of data blocks may include, for a given message, one or more second data blocks to indicate the connectivity capabilities. For example, the message may include a ‘Link’ block byte to indicate different connectivity capabilities. As an example, the ‘Link’ block byte may be as shown in Table 2 below:

TABLE 2

| | | | | |
|---|---|---|---|---|
| Optical | Ethernet | Wi-Fi | BT | HDMI |

The plurality of data blocks may include, for a given message, one or more third data blocks to indicate a status associated with the message. The status may include, for instance, link creation request status, created ink status, control request status, etc. An example of the pre-defined structure of the message is shown in Table 3 below:

TABLE 3

| | | | | |
|---|---|---|---|---|
| Header | Opcode | Code | Link | Status |

In one or more embodiments, data may be sent in multiple connecting messages. The plurality of data blocks may further include ‘count’ block and ‘index’ block to indicate the total count of messages required to send data as well as the index of a particular message in the count. Another example of the pre-defined structure of the message is shown in Table 4 below:

TABLE 4

| | | | | | |
|---|---|---|---|---|---|
| Header | Opcode | Code | Count | Index | Data |

In one or more embodiments, messages sent over the dynamic link 240 may have information to differentiate it as dynamic link messages.

In one or more embodiments, the system 250, in particular the data loss predictor module 312, may be configured to detect possible CEC operations state where data drop may occur. Further, the data loss predictor module 312 may be configured to detect a condition among a plurality of conditions corresponding to the data drop during transmission or reception of the one or more data items via the HDMI CEC line 230.

As mentioned previously, messages may be lost or dropped during transmission and reception in multiple scenarios, such as, when input rate is higher than the rate supported by the HDMI CEC line 230, when multiple devices send messages over the HDMI CEC line 230, when errors occur in HDMI CEC line signaling, when responses to the messages are missed due to congestion, etc.

The data loss predictor module 312 may thus be configured to detect a condition corresponding to the data drop during transmission or reception of the one or more data items via the HDMI CEC line 230. In one or more embodiments, the condition may be a first condition indicating that an input data rate at which the CEC service module 310 feeds the one or more data items to the HDMI CEC line 230 is greater than a threshold rate. The threshold rate may be the bit rate supported by the HDMI CEC line 230. In one or more embodiments, the condition may be a second condition indicating that the one or more data items are lost due to arbitration error. In one or more embodiments, the condition may be a third condition indicating that an expected response is not received from the second device 220 in response to the transmission of the one or more data items via the HDMI CEC line 230.

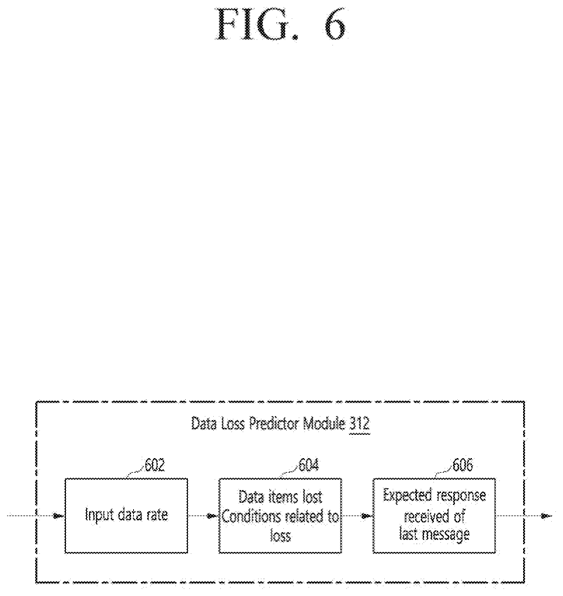

Referring to FIG. 6, an operational flow associated with the data loss predictor module 312 is illustrated. At operation 602, the data loss predictor module 312 is configured to determine the input data rate at which the CEC service module 310 feeds the one or more data items to the HDMI CEC line 230. At operation 604, the data loss predictor module 312 is configured to determine whether the one or more data items are lost. Further, the data loss predictor module 312 is configured to determine the condition corresponding to the loss of the one or more data items, which may include arbitration error, error in CEC line 230, negative acknowledgement (NACK) message, etc. At operation 606, the data loss predictor module 312 is configured to determine whether the expected response is received corresponding to a last message. Upon determining that the expected response is not received, the data loss predictor module 312 is configured to detect data loss on the HDMI CEC line 230.

In one or more embodiments, the data loss predictor module 312 may be configured to save, in the memory 304, the input rate where lossless CEC transmission happened over the HDMI CEC line 230. In one or more embodiments, the saved input rate may be updated in future iterations based on feedback from operations 604 and 606 above.

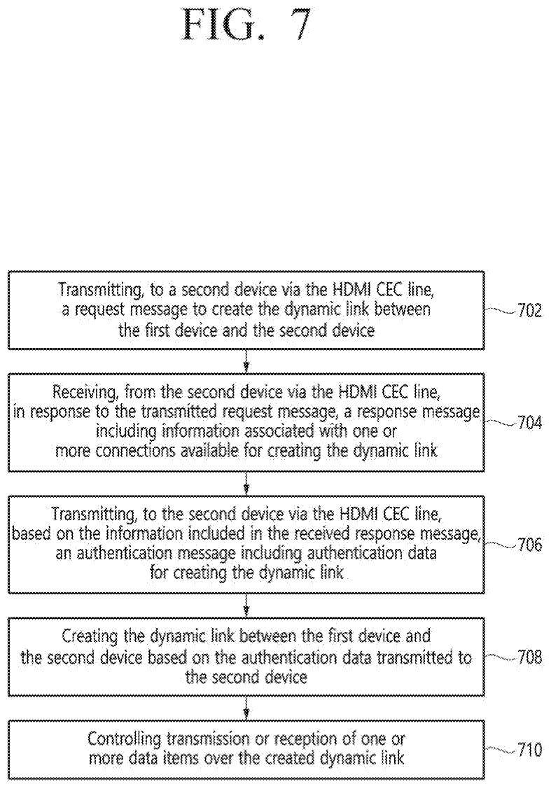

FIG. 7 illustrates an exemplary process flow of a method 700 for creating a dynamic link, such as the dynamic link 240, to prevent HDMI CEC line data drop, according to an embodiment of the present disclosure. In one or more embodiments, the operations of the method 700 may be performed by the system 250 at the first device 210. For instance, the method 700 may be performed by the processor 302 of the system 250 in conjunction with the plurality of modules 301 and the memory 304.

At operation 702, a request message to create the dynamic link 240 between the first device 210 and the second device 220 is transmitted to the second device 220 via the HDMI CEC line 230. In one or more embodiments, the request message includes connectivity capability of the first device 210 to connect with the second device 220. In one or more embodiments, the connectivity capability of the first device 210 includes at least one of a Wi-Fi connection capability, a Bluetooth connection capability, an optical connection capability, an Ethernet connection capability, or other possible connectivity capable of data transmission.

In one or more embodiments, the request message to create the dynamic link 240 further includes a request to create the dynamic link 240 using an optimal connectivity. In one or more embodiments, the optimal connectivity is identified based on the connectivity capability of the first device 210, the one or more connections that are available with the second device 220, and data transmission speed of the one or more connections.

At operation 704, a response message is received from the second device 220 via the HDMI CEC line 230 in response to the transmitted request message. The response message includes information associated with one or more connections available for creating the dynamic link 240. In one or more embodiments, the one or more connections available with the second device 220 for creating the dynamic link 240 includes at least one of a Wi-Fi connection, a Bluetooth connection, an optical connection, or an Ethernet connection.

At operation 706, based on the information included in the received response message, an authentication message is transmitted to the second device 220 via the HDMI CEC line 230. The authentication message includes authentication data for creating the dynamic link 240. In one or more embodiments, the authentication data may include one of Bluetooth MAC address for a Bluetooth connection, authentication information for a Wi-Fi connection, and authentication information for other possible connections which require authorization.

At operation 708, the dynamic link 240 between the first device 210 and the second device 220 is created based on the authentication data.

At operation 710, transmission or reception of one or more data items is controlled over the created dynamic link 240. In one or more embodiments, a control message is transmitted to the second device 220 via the HDMI CEC line 230 to control the connection state of the dynamic link 240.

In one or more embodiments, the method 700 may further include detecting a condition among a plurality of conditions corresponding to a data drop during transmission or reception of the one or more data items via the HDMI CEC line 230.

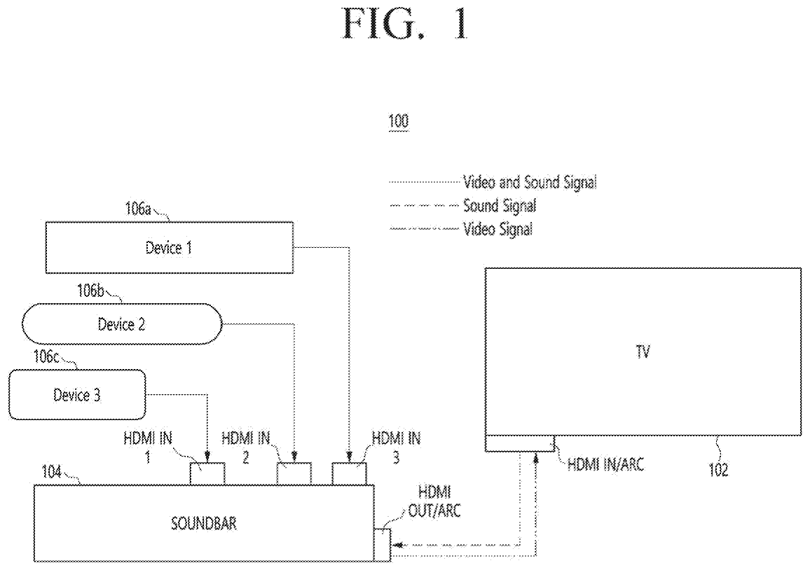

While the above discussed operations in FIG. 7 are shown and described in a particular sequence, the operations may occur in variations to the sequence in accordance with various embodiments. Further, a detailed description related to the various operations of FIG. 7 is already covered in the description related to FIGS. 1 to 6 and is omitted herein for the sake of brevity.

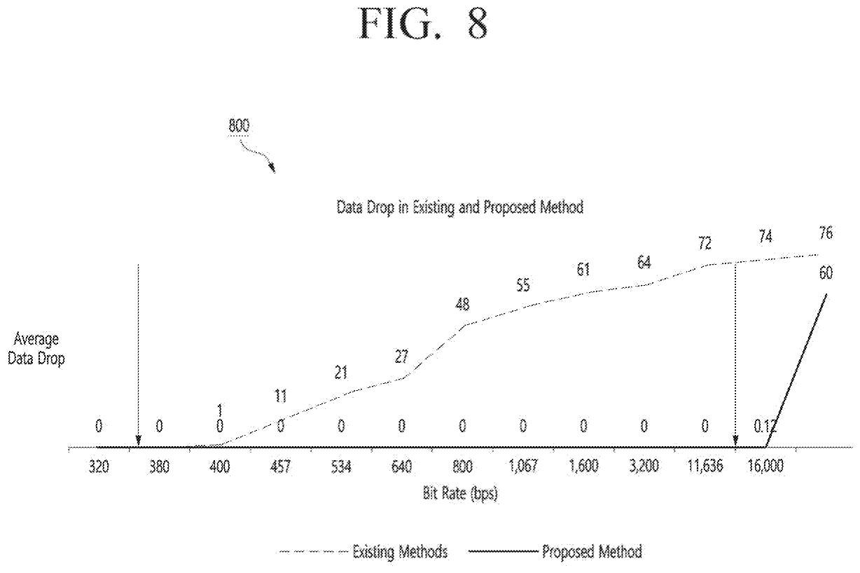

Referring to FIG. 8, a graphical representation 800 showing a comparison of data drop during multiple message transmission as per the method disclosed herein and data drop as per related art techniques is illustrated. The graphical representation 800 shows average data drop relative to the bit rate. As seen in FIG. 8, as per related art techniques where the HDMI CEC line 230 is used by itself, the maximum speed of loss-less data transmission is 363 bps. However, as per the disclosed method, the maximum speed (with dynamic link) of loss-less transmission is 11636 bps which is substantially greater when compared to the related art technique.

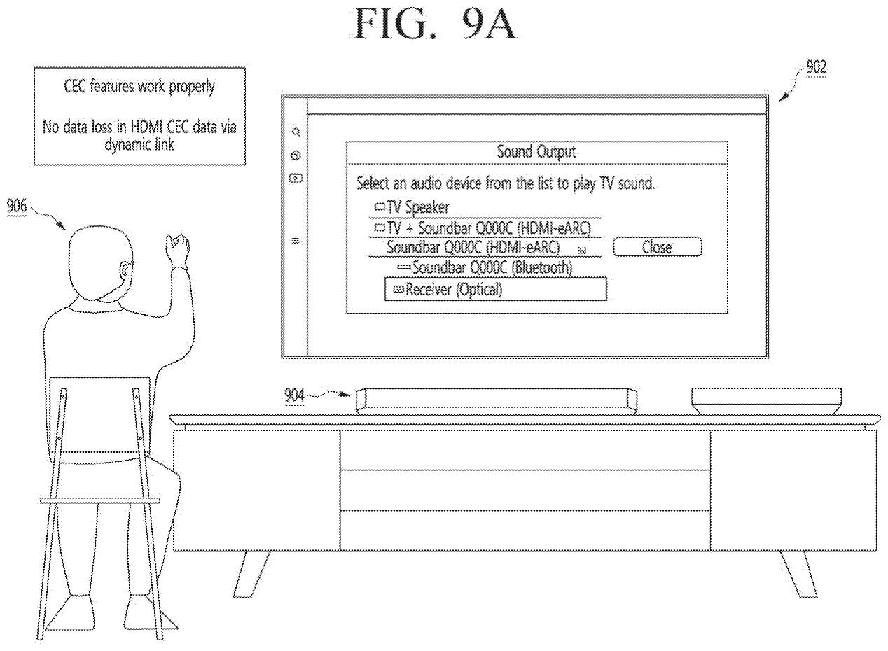

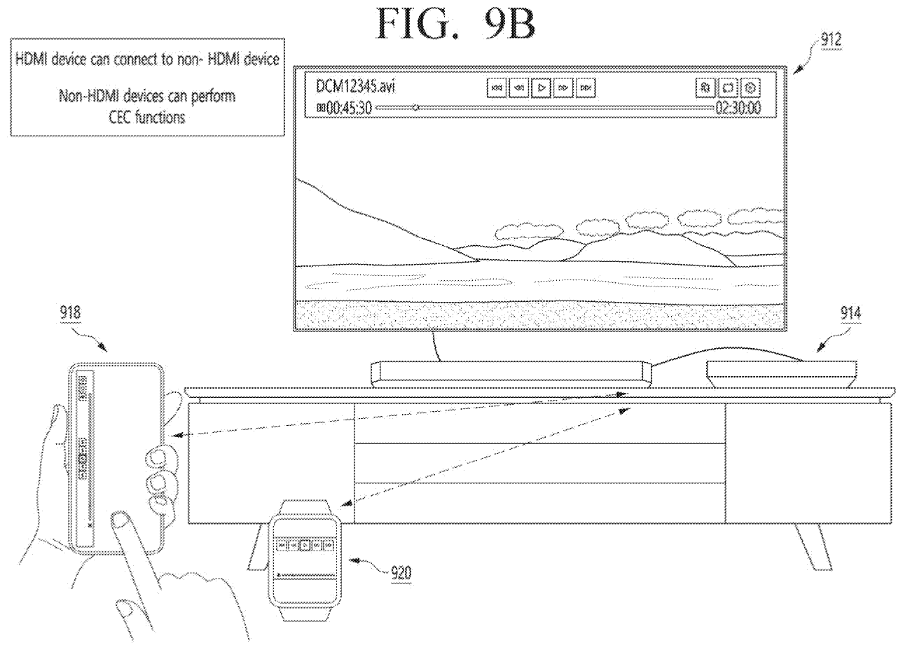

FIG. 9A illustrates an exemplary usage scenario of the method and system related to creation and use of the dynamic link for data transmission, according to an embodiment of the present disclosure. As seen in FIG. 9A, a television 902 and a sound device 904 may be in communication via an HDFC CEC line. A user 906 may be viewing content on the television and may select the CEC option to enhance the user experience through CEC features. As per related art techniques, data transmission may happen via the HDFC CEC line 230 only which may lead to data drop and the CEC features may not work properly, leading to diminishing the user experience. However, as per the disclosed system and method, the dynamic link 240 may be created between the television 902 and the sound device 904. As a result, dynamic load sharing between the HDMI CEC line 230 and the dynamic link 240 may be provided, thereby preventing data loss in the HDMI CEC line 230. The CEC features on the connected devices thus operate smoothly leading to enhanced user experience.

FIG. 9B illustrates another exemplary usage scenario of the method and system related to creation and use of the dynamic link 240 for data transmission, according to an embodiment of the present disclosure. As seen in FIG. 9B, a television 912 and a sound device 914 may be in communication via an HDFC CEC line forming a CEC network. Further, a user may be viewing content on the television 912. The user may be using one or more non-HDMI user devices, such as mobile phone 918 and smartwatch 920 while viewing the content. The user may select the CEC option to enhance the user experience through CEC features. As per related art techniques, the non-HDMI devices cannot be made part of the CEC network, rather, additional applications may need to be installed on the non-HDMI devices to connect to the CEC network. However, as per the disclosed system and method, the dynamic link 240 may be created between the television 912, the sound device 914, as well as the non-HDMI devices, i.e., the mobile phone 918 and the smartwatch 920. For example, the dynamic link 240 may be created using available connectivity such as Bluetooth. As a result, non-HDMI devices may be part of the CEC network and the user may control CEC features using the mobile phone 918 and/or the smartwatch 920. For instance, the user may control (pause/play/seek) the content on the television 912. Thus, not only is the user experience enhanced but also the load is shared between the HDMI CEC line 230 and the dynamic link 240 to enable seamless operation of CEC features.

The present disclosure provides for various technical advancements based on the key features discussed above. The present disclosure allows creation of the dynamic link 240 with higher speed of CEC data transmission and mitigating the restriction of existing HDMI CEC limit. Higher speed dynamic link is used for offloading the data load of existing HDMI CEC line 230. Thus, higher data transmission rates can be achieved using the dynamic link 240 without violating HDMI CEC standards Further, the present disclosure allows detection of data drop over the HDMI CEC line 230 and thereafter, further data drop may be prevented by offloading the load using the dynamic link 240. Additionally, non-HDMI devices can also connect with CEC network, thereby achieving a connected multi device environment. The CEC features can thus be controlled via the non-HDMI devices as well. Moreover, new CEC features can be implemented since data transmission can be achieved at higher speed using the dynamic link 240.

While specific language has been used to describe the present subject matter, any limitations arising on account thereto, are not intended. As would be apparent to a person in the art, various working modifications may be made to the method in order to implement the disclosure as taught herein. The drawings and the foregoing description give examples of embodiments. Those skilled in the art will appreciate that one or more of the described elements may well be combined into a single functional element. Alternatively, certain elements may be split into multiple functional elements. Elements from one or more embodiments may be added to another embodiment.

What is claimed is:

1. An electronic device comprising:
a communication interface configured to communicate with another device;
memory storing instructions; and
at least one processor,
wherein the instructions, when executed by the at least one processor individually or collectively, cause the electronic device to:
transmit, to the other device via a High-Definition Multimedia Interface (HDMI) Consumer Electronics Control (CEC) line, a request message to create a dynamic link between the electronic device and the other device);
receive, from the other device via the HDMI CEC line, a response message in response to the transmitted request message, the response message comprising information associated with one or more connections available for creating the dynamic link;
transmit, to the other device via the HDMI CEC line, based on the information associated with the one or more connections available for creating the dynamic link, an authentication message comprising authentication data for establishing the dynamic link;
create the dynamic link between the electronic device and the other device based on the authentication data; and
control at least one transmission or reception of one or more data items via the dynamic link.

2. The electronic device of claim 1, wherein the request message comprises information regarding a connectivity capability of the electronic device to connect with the other device, and
wherein the connectivity capability of the electronic device comprises at least one of a Wi-Fi connection capability, a Bluetooth connection capability, an optical connection capability, or an Ethernet connection capability.

3. The electronic device of claim 2, wherein the one or more connections available with the other device for creating the dynamic link comprise at least one of a Wi-Fi connection, a Bluetooth connection, an optical connection, or an Ethernet connection.

4. The electronic device of claim 3, wherein the request message to create the dynamic link further comprises a request to create the dynamic link using an optimal connectivity, and
wherein the instructions, when executed by the at least one processor individually or collectively, further cause the electronic device to identify the optimal connectivity based on the connectivity capability of the electronic device, the one or more connections that are available with the other device, and data transmission speed of the one or more connections.

5. The electronic device of claim 1, wherein the authentication data comprises a Bluetooth Media Access Control (BT MAC) address for a Bluetooth connection or authentication information for a Wi-Fi connection.

6. The electronic device of claim 2, wherein the instructions, when executed by the at least one processor individually or collectively, further cause the electronic device to transmit, to the other device via the HDMI CEC line, a control message to control a connection state of the dynamic link.

7. The electronic device of claim 6, wherein each of the request message, the response message, the authentication message, and the control message has a predefined structure, and
wherein the predefined structure comprises one or more first data blocks to indicate a type of a corresponding message, one or more second data blocks to indicate the connectivity capability, and one or more third data blocks to indicate a status associated with the corresponding message.

8. The electronic device of claim 1, the instructions, when executed by the at least one processor individually or collectively, further cause the electronic device to:
detect a condition among a plurality of conditions corresponding to a data drop during transmission or reception of the one or more data items via the HDMI CEC line.

9. The electronic device of claim 8, wherein a first condition among the plurality of conditions indicates that an input data rate at which a CEC service feeds the one or more data items to the CEC line is greater than a threshold rate,
wherein a second condition among the plurality of conditions indicates that the one or more data items are lost due to arbitration error, and
wherein a third condition among the plurality of conditions indicates an expected response is not received from the other device in response to the transmission of the one or more data items via the HDMI CEC line.

10. A method performed by a first device for creating a dynamic link to prevent High-Definition Multimedia Interface (HDMI) Consumer Electronics Control (CEC) line data drop, the method comprising:
transmitting, to a second device via an HDMI CEC line, a request message to create the dynamic link between the first device and the second device;
receiving, from the second device via the HDMI CEC line, a response message in response to the transmitted request message, the response message comprising information associated with one or more connections available for creating the dynamic link;
transmitting, to the second device via the HDMI CEC line, based on the information associated with the one or more connections available for creating the dynamic link, an authentication message comprising authentication data for creating the dynamic link;
creating the dynamic link between the first device and the second device based on the authentication data; and
controlling at least one of transmission or reception of one or more data items via the dynamic link.

11. The method of claim 10, wherein the request message comprises information regarding a connectivity capability of the first device to connect with the second device, and
wherein the connectivity capability of the first device comprises at least one of a Wi-Fi connection capability, a Bluetooth connection capability, an optical connection capability, or an Ethernet connection capability.

12. The method of claim 11, wherein the one or more connections available with the second device for creating the dynamic link comprises at least one of a Wi-Fi connection, a Bluetooth connection, an optical connection, or an Ethernet connection.

13. The method of claim 12, wherein the request message to create the dynamic link further comprises a request to create the dynamic link using an optimal connectivity, and
wherein the method further comprises identifying the optimal connectivity based on the connectivity capability of the first device, the one or more connections that are available with the second device, and data transmission speed of the one or more connections.

14. The method of claim 10, wherein the authentication data comprises Bluetooth Media Access Control (BT MAC) address for a Bluetooth connection or authentication information for a Wi-Fi connection.

15. The method of claim 11, further comprising transmitting, to the second device via the HDMI CEC line, a control message to control a connection state of the dynamic link.

16. The method of claim 15, wherein each of the request message, the response message, the authentication message, and the control message has a predefined structure, and
wherein the predefined structure comprises one or more first data blocks to indicate a type of a corresponding message, one or more second data blocks to indicate the connectivity capability, and one or more third data blocks to indicate a status associated with the corresponding message.

17. The method of claim 10, further comprising detecting a condition among a plurality of conditions corresponding to a data drop during transmission or reception of the one or more data items via the HDMI CEC line.

18. The method of claim 17, a first condition among the plurality of conditions indicates that an input data rate at which a CEC service feeds the one or more data items to the CEC line is greater than a threshold rate,
wherein a second condition among the plurality of conditions indicates that the one or more data items are lost due to arbitration error, and
wherein a third condition among the plurality of conditions indicates an expected response is not received from the second device in response to the transmission of the one or more data items via the HDMI CEC line.
